(19) United States
(12) Patent Application Publication
(10) Pub. No.: US 2026/0127613 A1
(43) Pub. Date: May 7, 2026

(54) REAL-TIME COUNTER-FACILITATED RETRIEVAL OF AGGREGATED VALUES FOR PERFORMANCE OF A PROCESSING OPERATION

(71) Applicant: PayPal, Inc., San Jose, CA (US)

(72) Inventors: Arpit Kumar, San Jose, CA (US); Priya Gopalakrishnan, San Jose, CA (US); Murali Krishna Sampath Kumar, Quincy, MA (US); Jayaram Venugopal, Coimbatore (IN); Ravidutta Ramesh Kodre, San Jose, CA (US); Anup Rameshrao Ghagre, Karanja (IN); Shu Liu, Shanghai (CN); Yingying Tao, Shanghai (CN)

(21) Appl. No.: 18/954,793

(22) Filed: Nov. 21, 2024

(30) Foreign Application Priority Data
Nov. 1, 2024 (WO) PCT/CN2024/129211

(51) Int. Cl. G06Q 20/40

(52) U.S. Cl. CPC G06Q 20/4016

(57) ABSTRACT

A computer system performs a processing operation in real time on an aggregated value stored in a counter of a set of counters corresponding to time periods associated with events. The computer system maintains the set of counters usable to store aggregated values of an event metric. In response to detection of the events, the computer system stores, in a database, event details for the received events and updates those counters of the set of counters that correspond to time periods associated with the received events. In response to receipt, in a current time period, of an update to a particular event of the received events associated with a previous time period, the computer system, in real time, retrieves, from the set of counters, a particular aggregated value of the event metric for the previous time period and performs a processing operation based on the particular aggregated value.

The present application claims priority to PCT Appl. No. PCT/CN2024/129211, entitled “REAL-TIME COUNTER-FACILITATED RETRIEVAL OF AGGREGATED VALUES FOR PERFORMANCE OF A PROCESSING OPERATION”, filed Nov. 1, 2024, which is incorporated by reference herein in its entirety.

### BACKGROUND

### Technical Field

This disclosure relates generally to processing of events by computer systems, and more particularly, to real-time processing of updates to events.

### Description of the Related Art

Real-time processing performed by computer services is a critical aspect of modern technology, allowing for rapid responses to data input. This type of processing is essential in various industries, including finance, healthcare, computer security, and telecommunications, in which split-second decisions and actions can have significant consequences. Real-time processing allows for quick decision-making, rapid responses to changing conditions, and the ability to provide up-to-date information to users.

Computer services today are also commonly tasked with processing extremely large volumes of data. Payment services, for example, may be expected to handle at least millions of transactions a minute, and store information about these transactions for some length of time. Computer security services, as another example, may monitor and evaluate at least hundreds of thousands of security events at a time to adequately protect against cyber threats and data breaches.

### BRIEF DESCRIPTION OF THE DRAWINGS

FIG. 1 illustrates one embodiment of a computer system configured to perform a processing operation in real time based on retrieving an aggregated value from a counter of a set of counters.

FIG. 2 illustrates an example event processing subsystem of the computer system.

FIG. 3 depicts an example database operable to store event details associated with an event.

FIG. 4A depicts an example plurality of counters usable to store aggregated values and aggregated update values for a plurality of time periods.

FIG. 4B depicts an example of counter logic.

FIG. 5A depicts examples of an event and an update event corresponding to the event.

FIG. 5B depicts an example batch file that includes a plurality of update events.

FIG. 6A illustrates one embodiment of an update control subsystem.

FIG. 6B is a flow diagram of one embodiment of a method to initiate a processing operation.

FIG. 7 is a flow diagram of one embodiment of a processing operation.

FIG. 8 is a flow diagram illustrating a specific example of a processing operation applied to a chargeback scenario.

FIG. 9 is an example timing diagram illustrating temporal aspects of a processing operation.

FIG. 10 is a block diagram illustrating an example of a computer system configured to implement a transaction service.

FIG. 11 is a flow diagram of one embodiment of a method for real-time counter-facilitated retrieval of aggregated values for performance of a processing operation.

FIG. 12 is a flow diagram of one embodiment of a method for real-time counter-facilitated retrieval of aggregated values for performance of a processing operation.

FIG. 13 is a block diagram of another embodiment of a computer system configured to implement a transaction service.

### DETAILED DESCRIPTION

This disclosure concerns computer services that execute on computer systems that are referred to as event processing systems. These computer systems are operable to recognize and take action in response to detection of certain occurrences or triggers, which are referred to herein as “events.” A given event processing system is operable to recognize a particular set of events. In one such system, receipt of a user financial transaction is an event. Detecting a network communication (e.g., source IP address, destination IP address, ports involved, etc.) is an event for another event processing system. Event processing systems are operable to gather data associated with events (which may be referred to herein as “event data” or “event details”) and use this data to determine how to respond to those events. Services implemented by computer systems frequently handle large volumes of events.

Additionally, computer services may frequently need or desire to retain information about events for subsequent processing. When the number of such events is large (e.g., in the billions) and the length of retention is relatively long (e.g., up to one year), the size of the data store (e.g., a database) needed to house this information can be exceedingly large. The latency required to access such a data store grows with the size of the data store.

Consider a scenario in which a computer service receives an indication of an event that is related to one or more prior events stored in a high-volume data store, and the processing of which depends on accessing—in real time—information about those prior events. The event may be considered an “update event” to a prior event in some cases. In a payment context, the update event may be a “chargeback”—that is, an indication that a prior transaction is fraudulent and should be refunded by the merchant. In the computer security context, the update event may be related to one or more earlier events in terms of similar properties or modus operandi of attack.

Consider a scenario in which it is desired or required to process one of these update events in real time. As is understood in the art, “real-time” processing refers to processing in which events are handled nearly instantaneously, which for purposes of this disclosure is understood to be within at least one second. In many implementations, however, real-time responses are expected to be on the order of milliseconds or sometimes microseconds. Note that a real-time system does not necessarily guarantee real-time results—real-time processing fails if it does not meet a specified deadline relative to an event. When processing of later-in-time events depends on details of one or more related earlier events that reside in a data store, the size of the data store can hinder or prevent real-time processing. As will be described, in some cases, it might be desirable to handle the processing of a chargeback in a manner that depends on a volume of other events in the time period in which the original transaction occurred. In a high-volume scenario, such processing might necessitate accessing the data store to compile information on at least millions of prior events. Even with high-powered modern computer systems, real-time processing of the chargeback will likely not be possible. In some cases, conventional computer systems may attempt to solve the foregoing problem by sacrificing computational accuracy for real-time processing or, alternatively, by providing static solutions for handling updates that generally are not as accurate as desired for individual instances of update events.

To address this scenario, the present disclosure addresses the desirability of separate counter values that store aggregated data values to facilitate processing of update events. As events are initially processed, any event details that relate to values to be stored in a counter are used to update the relevant counter and provide an aggregated value of some quantity. For example, an aggregated value, corresponding to the total transaction volume of all transactions for a particular merchant in a particular month, might be stored in a counter for that merchant/month. Consider a situation in which a chargeback is received months later for a transaction that occurred in the particular month, and processing of the chargeback depends on the total transaction volume for that merchant/month. The total transaction volume can be retrieved from the relevant counter, and advantageously used to process the chargeback in real time. Contrast this situation with one in which the total transaction volume would have to be computed at the time of the chargeback. This would not be possible in real time in many or most cases, because, to calculate the total transaction volume at the time of chargeback, the computer system would have to access the data store and identify, from among potentially terabytes or petabytes of data, events that are relevant to calculating the total transaction volume, which would most likely prevent real-time data processing at the time of chargeback. This situation would be exacerbated when multiple or many chargebacks are received at the same time—for example, when processing a daily batch file of chargebacks. Note that chargebacks are just one example of this potential problem, and that the teachings of the present disclosure extend beyond the above-described problem of real-time processing of chargebacks.

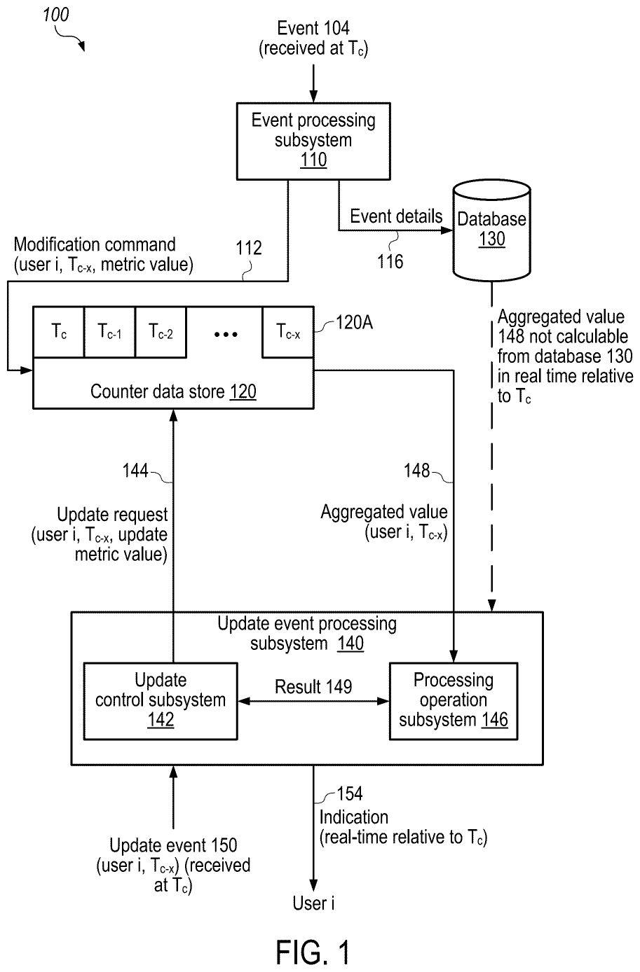

FIG. 1 illustrates one embodiment of a computer system configured to perform a processing operation in real time based on retrieving an aggregated value from a counter of a set of counters. In response to receipt of an update event that is associated with an event that occurred prior to occurrence of the update event, the computer system performs a processing operation. To perform the processing operation and in some embodiments, the computer system retrieves a first aggregated value from a first counter of the set of counters and a second aggregated value from a second counter of the set of counters. The computer system determines a threshold based on the first aggregated value and compares the threshold with the second aggregated value, adjusted based on an update value metric included in details of the update event, to generate a result. Based on the result, the computer system initiates an action. The action may include, for example, transmission, to a user of the computer system, an indication of a result of the processing operation.

Depicted in FIG. 1 computer system 100 is a multi-user computer system that includes event processing subsystem 110, counter data store 120, database 130, and update event processing subsystem 140. The term “subsystem” connotes hardware (e.g., circuitry), firmware, software, or a combination thereof configured to or operable to perform the functionality described herein. Update event processing subsystem 140 includes update control subsystem 142 and processing operation subsystem 146. Broadly, event processing subsystem 110 is configured to process events, such as event 104, and update event processing subsystem 140 is configured to process update events, such as update event 150.

Consider event 104 received by event processing subsystem 110 at a first given time period (e.g., T_{c}). Event 104 may be associated with multiple items of constituent event data, which may collectively be referred to as event details 116. Event details 116 may include, without limitation, a timestamp value, an ID value for the event, and various other types of data (e.g. event source/destination). As depicted, event processing subsystem 110 is configured to send event details 116 to database 130 for retention for some specified period of time. (For example, transactions in a payment service may be retained for up to a year in some implementations.) Database 130 may correspond to any known database provider or architecture. In many cases, database 130 may include vast quantities of data, such as terabytes or petabytes of data. Note that the data included in database 130 may be event data associated with multiple users of computer system 100.

In addition to sending event details 116 to database 130, event processing subsystem 110 may cause an update to one or more of a plurality of counters 120 in response to a particular event 104. Counters 120 are used in embodiments disclosed herein to aggregate values of a particular metric that are included in various events received by event processing subsystem 110. For example, database 130 may store event details 116 for many hundreds of payment transactions for a particular user. But counters 120 can be used to keep a running total of some particular metric that is present in one or more of these hundreds of transactions. For example, a particular one of counters 120 may store an aggregate value of the total amount of transactions involving a particular user in a particular time period. As depicted, an update to a particular counter 120 may be initiated by issuance of a modification command 112. In one implementation, modification command 112 may specify a particular user, a particular time period, and a particular metric value (e.g., amount of a transaction corresponding to event 104); in response, counter data store is operable to add the metric value amount to a counter corresponding to (user i, time period T_{c-x}).

Counter data store 120 may include a plurality of counters associated with a plurality of users of computer system 100. For example, a first plurality of counters 120A may be associated with a first user of the plurality of users, while other pluralities of counters (not depicted) may be associated with other users of the plurality of users. A given plurality of counters for a particular user may correspond to different time periods. For example, each of plurality of counters 120A may be associated with a different month within a large period (e.g., 12 counters, each one for one of the last 12 months). In this example, the current month's counter might be denoted as T_{c}, with the previous month being denoted at T_{c-1}, etc. The aggregated value in these counters may be stored in any suitable format, including integer, floating point, etc.

In addition to processing events 104, computer system 100 is also configured to process updates to events 104. Update event 150 may correspond to a modification to event 104, the modification occurring at a time subsequent to a time at which event 104 occurred. For example, event 104 may correspond to a security intrusion event with a computer network, while update event 150 may correspond to a classification of the security intrusion event, such as an indication that the security intrusion event was a lateral attack.

Consider update event 150, which is associated with user i and an event that occurred in time period T_{c-x} (update event is received in time period T_{c}). Like event 104, update event 150 may be associated with a plurality of data values (e.g., fields of a larger value). For instance, update event 150 may be associated with an ID field that includes a user ID identifying user i, an event identifier field that includes an event identifier linking update event 150 to a particular event 104, or both. Additionally, update event 150 may be associated with a time field that indicates a time at which update event 150 is received at computer system 100 and an update metric value field that includes an update metric value (e.g., a transaction quantity) associated with update event 150. For example, update metric value field might include an amount of goods and services that are being charged back (i.e., reported as fraud) within a transaction payment system.

In one embodiment, processing update event 150 involves accessing one of counters 120 that corresponds to the user (i) and time period when the event originally occurred (time period T_{c-x}) in order to process the update. Accordingly, update event processing subsystem 140 generates update request 144, which causes aggregated value 148 to be returned from the appropriate counter 120. Processing operation subsystem 146 is executable to use aggregated value to perform some operation whose outcome determines how update event 150 is to be handled. For example, processing operation subsystem 146 may compute some threshold and then generate data related to the original event in order to determine how update event 150 should be handled. Result 149 of this processing may be returned to update control subsystem 142, which in turn provide indication 154 to user i indicating a manner in which update event 150 was handled.

Storing aggregated value 148 in a counter of the plurality of metric counters 120A may advantageously facilitate real-time processing by computer system 100. Consider a scenario in which update event 150 is detected by update event processing subsystem 140. If processing of update event 150 depends on aggregated value 148, the ability of update event processing subsystem 140 to access aggregated value 148 from counter data store 120 can advantageously permit update event 150 to be processed in real time. Real-time processing of update event 150 may not be possible if aggregated value 148 would need to be computed from many different events stored in database 130. Each access to a particular set of event details 116 in database 130 that would be needed to recompute aggregated value 148 adds latency, and if a sufficient number of different sets of event details need to be accessed, the total latency will fall outside the ambit of real-time processing.

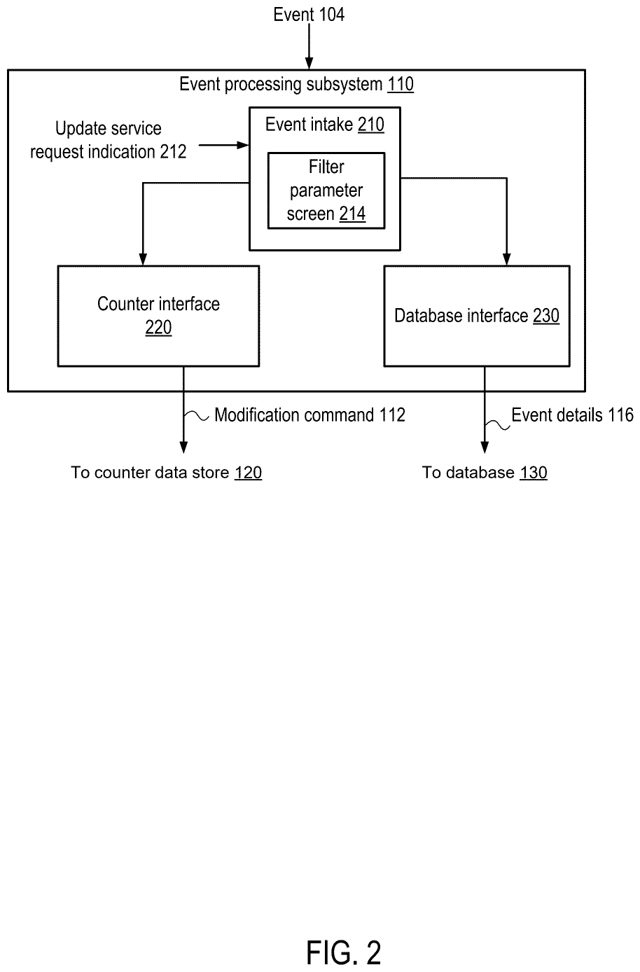

FIG. 2 illustrates one embodiment of an event processing subsystem. Event processing subsystem 110 includes event intake 210, counter interface 220, and database interface 230, which are software modules in one embodiment. Additionally, event intake 210 includes filter parameter screen 214. Event processing subsystem 110 is executable to forward event data for further processing by other components of computer system 100. In particular, event processing subsystem 110 determines whether to forward event data to counter data store 120 and/or database 130.

Event intake is executable to receive event 104 and determine how to route its constituent information based on a user associated with event 104 and filtering criteria that has been set up. In some embodiments, not every event will cause information to be sent to counter data store 120. In some cases, a particular user of a service associated with computer system 100 may specifically have to make a request that causes information associated with a given event to be sent to counter data store 120. The request, from a user's perspective, may simply be to invoke some previously unavailable functionality, and thus the use of counters may be invisible to the requesting user.

One example of such a request is update service request indication 212, which is received from a particular user of computer system 100. When event intake 210 receives update service request indication 212 from a particular user (e.g., user i), event intake 210 can send an instruction to counter interface 220 to establish a set of counters for the particular user. Subsequently, when event details associated with event 104 is received by event intake 210, a user id associated with the event will be checked to determine whether it is on a list of user ids for which the counter functionality is to be enacted. If the current user id is enabled for counter usage, event intake 210 will forward event details associated with event 104 to counter interface 120. Otherwise, event details will not be forwarded to counter interface 120.

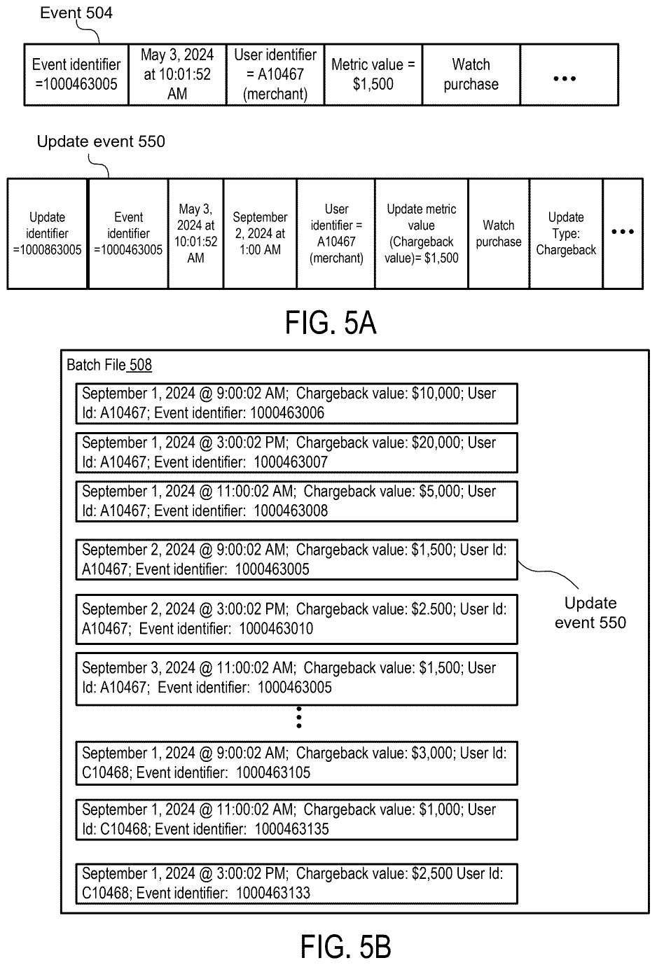

One example of higher-level functionality that may be enabled by update service request indication 212 is described below with respect to FIGS. 5A-B.

Filter parameter screen 214 is also executable to enable or inhibit forwarding of event details relating to event 104 within event processing subsystem 110. Filter parameter screen 214 may store any set of criteria that has been established, such as by a user of computer system 100. For example, a rule within filter parameter screen 214 may specify that events within certain time ranges are not to be processed. Other rules may specify that transactions below a certain amount, or security events with certain characteristics, are to receive no further handling. In this manner, filter parameter screen 214 may advantageously be used to restrict processing of only those events 104 that are desired by users of computer system 100. Note that filter parameter screen 214 may be used in conjunction with a list of users for which the counter functionality is enabled. Thus, event details may only be sent to counter interface to 220 in those scenarios in which both the counter functionality has been established by indication 212 and filter parameter screen 214 has indicated that processing is enabled. Still further, filter parameter screen 214 can be used to determine whether event details are to be sent to counter interface 220 and to database interface 230.

Counter interface 220 and database interface 230 are executable to interact with counter data store 120 and database 130, respectively. Counter interface 220, in particular, is executable to generate modification command 112. Command 112 may be generated by extracting the user ID and a particular metric value from event 104. Additionally, a time value representative of the current time period may also be included in modification command 112. Database interface 230, on the other hand, is executable 2 generate a query that places selected information associated with event 104 (event details 116) in database 130.

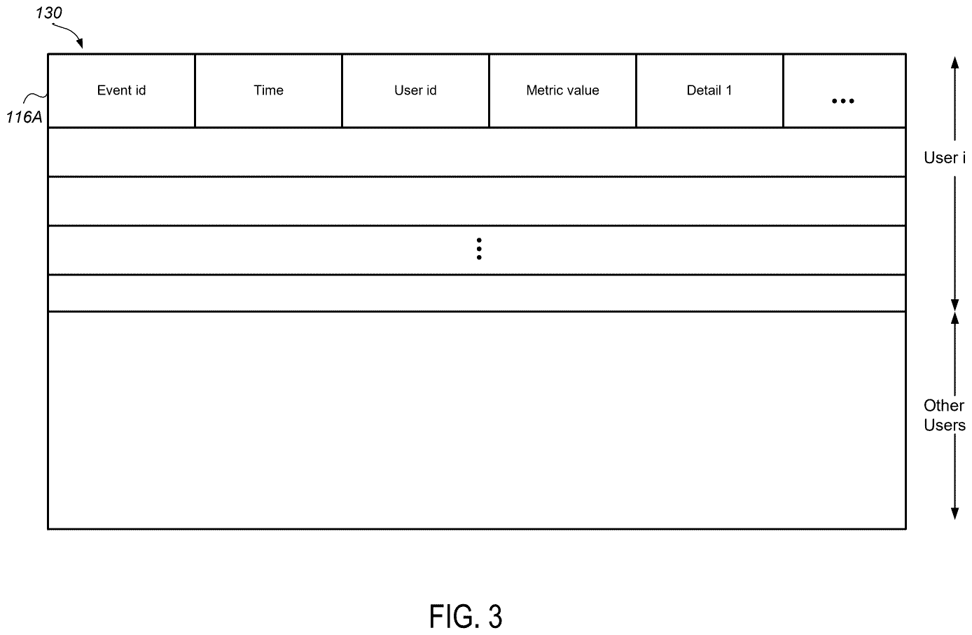

FIG. 3 depicts one embodiment of a database operable to store event details associated with an event. Database 130 stores event details 116, such as event details 116A, for a plurality of events, such as event 104. Such events may be associated with many different users of computer system 100 (e.g., user i and other users).

As depicted in FIG. 3, exemplary event detail 116A associated with user i of computer system 100 includes event ID, which may be a unique identifier for event 104 within a table of database 130 (e.g., a database key). Other event details include an indication of a time period associated with the event, (e.g., a date and a time at which event 104 occurred, a month, a quarter (Q3 of 2024), etc.). Event detail 116A may further include a user ID, which enables a determination of whether event information is to be sent to counter data store 120 based on a previously received indication 212. Still further, event detail 116A may include various other values, such as “metric value” and “Detail 1.” Metric value may correspond, in some implementations to a numerical value that can be aggregated for multiple events using counter data store 120. Detail 1 is representative of any other various types of information within event 104. For instance, in a financial context, the additional details may include a type of financial transaction (e.g., an indication of an item being purchased), a buyer id, etc. In a computer security context, the one or more additional details may correspond to various types of metadata (source or destination IP address or port number).

Database 130 is operable to store a plurality of event details associated with user i, and a plurality of event details associated with other users of computer system 100. In many cases, database 130 may be operable to store at least terabytes or petabytes of data. In some high-volume systems, database 130 may store many thousands or millions of events that are associated with a user. When processing an update event necessitates computing a value that is based on many different individual transactions stored in database 130, iterating through database 130 to identify these items of information would take significant time, in some cases precluding real-time processing of the update event.

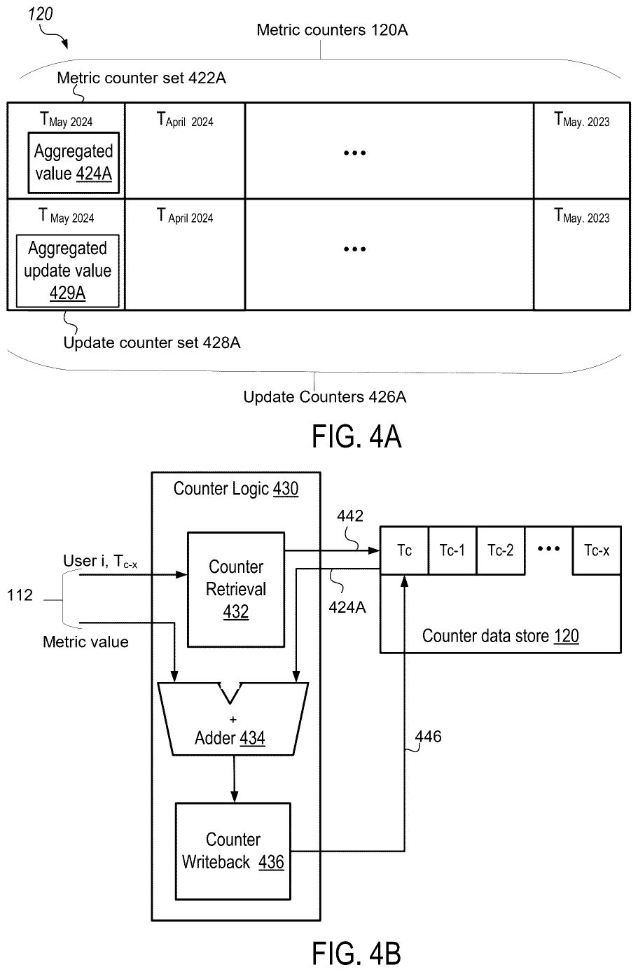

FIG. 4A depicts one embodiment of counter data store 120. As depicted, counter data store 120 includes metric counters 120A and update counters 426A. The illustrated counters in this figure (metric counter set 422A and update counter set 428A) all correspond to a particular user of computer system 100, but, of course, counter data store 120 can store sets of counters for any number of different users.

In this example, computer system 100 implements a transaction service; metric counters 120A and update counters 426A thus store aggregated values for the last year (i.e., the current month and the preceding 11 months). Metric counter set 422A may, for example, store a total transaction volume for each of the last 12 months, while update counter set 428A may, for example, store a total chargeback amount for each of the last 12 months. For example, if the current month is May 2024, metric counter set 422A stores aggregated value 424A for the metric value and aggregated update value 429A for the updates.

Although two sets of counters are shown here for a given user, in other implementations, different numbers of sets of counters may be appropriate.

FIG. 4B is a block diagram of one embodiment illustrating how counter data store 120 is updated. Counter logic 430 and counter data store 120 are depicted. Counter logic 430 includes a counter retrieval module 432, an adder module 434, and a counter writeback module 436. An update to a metric counter value is described here, but an update to an update counter value works the same way.

Based on the user ID, time period value, and metric value or update metric value associated with an event or an update event, counter logic 430 is executable to modify (e.g., increment or decrement) aggregated value 424A in metric counter 422A, aggregated update value 429A in update counter 428A, or both.

During operation, counter logic 430 is executable to receive modification command 112, which specifies a particular user (user i), a particular time period (e.g., year/month, T_{c-x}), and the metric value (e.g., current transaction cost) that is going to added to the running total. The user and time period values are provided to counter retrieval 432. Additionally, the metric value is provided as one input to adder 434. Counter retrieval 432 is executable to send access request 442, which includes the user ID and time period value, to counter data store 120. In response to access request 442, counter data store 120 provides aggregated value 424A to adder 434. Adder 434 is executable to combine the metric value and the aggregated value 424A to generate a modified aggregated value, which is provided to counter writeback 436. Counter writeback 436 is executable to initiate writeback operation 446 in which the modified aggregated value is written to the corresponding counter, replacing the previous aggregated value.

FIG. 5A depicts examples of an event and a related update event. Event 504 is a transaction in which a watch is purchased, while update event 550 is a chargeback in which the purchase is subsequently reported as fraud. Update event 550, as shown, includes a field that identifies the update event as a chargeback, along with various other fields. In this context, processing of update event 550 entails determining whether the chargeback value ($1500, the price of the watch), exceeds a certain threshold that is measured as a specified percentage of the total transaction volume for the month of the original purchase. For this reason, update event 550 is associated with event details such as a user identifier field and a month/year of the original purchase (here May 2024). As will be described, this information is usable to access counter data store 120 in order to determine the total transaction volume for May 2024.

While FIG. 5A is described in the context of a financial transaction, event 504 and update event 550 are not limited to this context. For example, in a computer security context, event 504 may correspond to an initial portion of a malicious attack, while update event 550 may correspond to a related lateral attack that is an extension of event 504.

FIG. 5B depicts an example batch file that may be processed by computer system 100. As depicted, batch file 508 includes a plurality of update events, including update event 550. Update event processing subsystem 140 may process update events stored in batch file 508 periodically, such as once a day or twice a week in some embodiments.

The functionality of computer system 100 to handle update events—that is, events that relate in some way to earlier events—has been discussed at length. In some implementations, a given event 104 can be recognized as an update event by event processing subsystem 110, and written to batch file 508. Update events may be accumulated in batch file 508 for some specified period of time. As shown in FIG. 5B, batch file 508 includes details for update events received over the course of Sep. 1-3, 2024. Update event 550 is associated with a number of details, including an event identifier that may be usable to link the update event to an earlier event. The event identifier may be used as a key to find the earlier event. In another implementation, the update event may simply specify the month/year of the earlier event.

Batch file 508 may be periodically processed (such as some regular interval) by update event processing subsystem 140 so that each of the update events is handled by the system. “Handling” an update event can take the form of any suitable processing operation. As has been explained, one possible form of handling an update event in a payment transaction service is to determine whether the chargeback will be covered by the merchant or the provider of the service of computer system 100, as described with respect to FIG. 5A. Update event processing system 140 is executable to handle each of the update events in batch file 508 in real time through the use of counter data store 120 (and thus obviating the need to reconstruct aggregated values by repeated accesses to database 130).

Note that a batch file need not be used to process update events. Instead, event processing subsystem 110 can route events identified as update events to update event processing system 140 for real-time handling at the time of receipt, if desired.

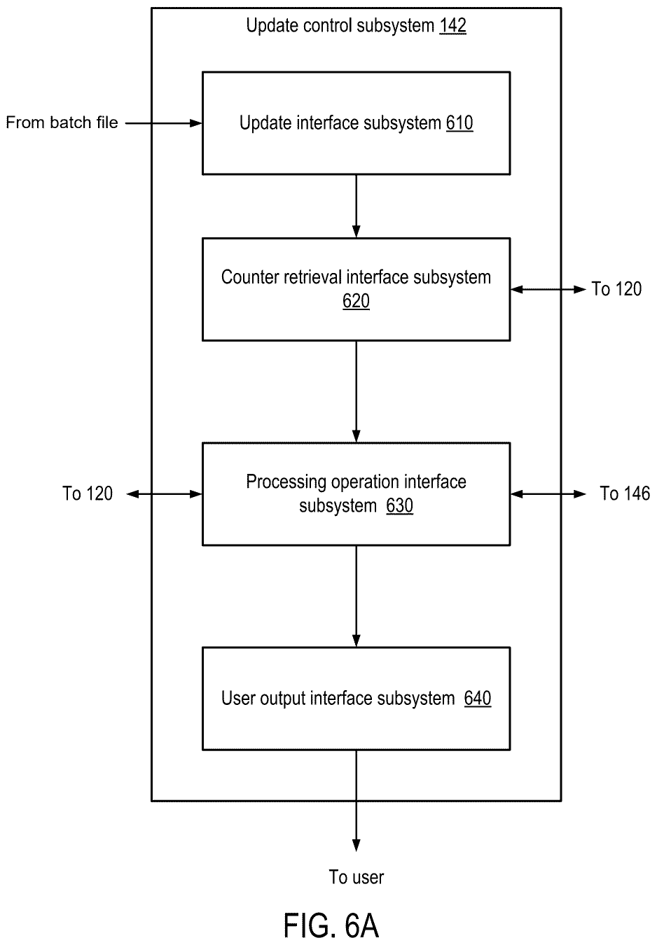

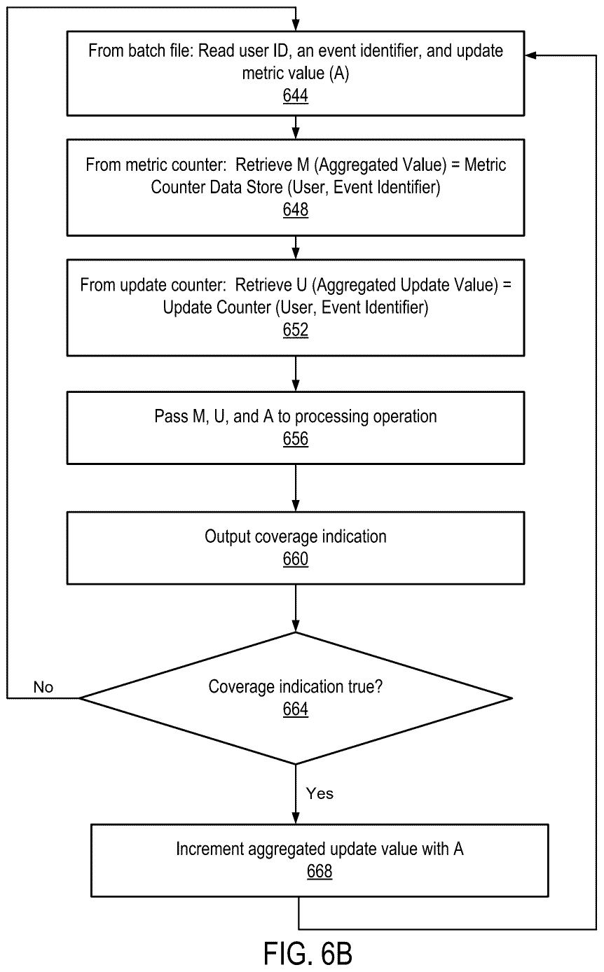

FIG. 6A is a block diagram of one embodiment of an update control subsystem. As depicted, update control subsystem 142 includes update interface subsystem 610, counter retrieval interface subsystem 620, processing operation interface subsystem 630, and user output interface subsystem 640. Update control subsystem 142 is executable to orchestrate accesses to counter data store 120 and to processing operation subsystem 146 to facilitate generation of an indication to a user (e.g., user i) of computer system 100.

Update interface subsystem 610 is executable to interact with a batch file, such as batch file 508, extract data from a batch file entry, and provide the extracted data to counter retrieval interface subsystem 620. For example, update interface subsystem 610 may be executable to extract a user id, an event identifier, and an update metric value included in a batch file entry to counter retrieval interface subsystem 620.

Counter retrieval interface subsystem 620 is executable to retrieve the appropriate counter values from counter data store 120 based on data provided by update interface subsystem 610. For example, based on the user id extracted from the batch file, both a set of metric counters and a set of update counters can be accessed. The retrieved information is provided to processing operation interface subsystem 630.

Processing operation interface subsystem 630 is executable to receive one or more aggregated values (e.g., aggregated value 424A) and one or more aggregated update values (e.g., aggregated updated value 429A) from counter retrieval interface subsystem 620 and to provide one or more of these values to processing operation subsystem 146, which actually performs the processing operation on details associated with the update event. Additionally, processing operation interface subsystem 630 is executable to provide one or more calculated values received from processing operation subsystem 146 (e.g., result 149) to one or more counters of counter data store 120. Further, processing operation interface subsystem 630 is executable to provide the one or more calculated values from processing operation subsystem 146 (e.g., result 149) to user output interface subsystem 640.

User output interface subsystem 640 is executable to generate an output of the processing operation, such as indication 154, based on the one or more calculated values received from processing operation interface subsystem 630. User output interface subsystem 640 is further executable, for example, to provide the indication to a device associated with a user of computer system 100.

FIG. 6B is a flow diagram of one embodiment of a method for performing a processing operation. In this particular implementation, computer system 100, based on the processing operation, is configured to determine whether to modify (e.g., increment or decrement) an aggregated update value, such as aggregated update value 429A, in accordance with an update metric value associated with an update event, such as update event 150.

At 644, update event control subsystem 142 is executable to read, from batch file 508, a user ID, an event identifier, an update metric value, denoted as variable “A,” from details of update event 150 included in batch file 508. For example, update event 150 may correspond to update event 550 and the variable “A” may have the value of $1,500.

At 648, update event control subsystem 142 is executable to link update event 150 to an earlier event 104, based on an event identifier included in the update event. For example, the event identifier may associate the update event with the earlier-in-time event. Alternatively, the update event may include information identifying the time period during which the event corresponding to the update event occurred. In response to linking update event 150 with event 104, update event control subsystem 142 is executable to retrieve the aggregated value, such as aggregated value 424A, from the metric counter corresponding to a time period associated with event 104, such as metric counter 422A. The aggregated value may be denoted as variable “M.” For example, in the financial transaction context, the aggregated value may correspond to a total payment volume of $20,000 for May 2024, the month and year corresponding to metric counter 422A.

At 652, based on the user ID, event identifier, time period information, or combinations thereof, update event control 142 is executable to retrieve the aggregated update value, such as aggregated update value 429A, from the update counter corresponding to a time period associated with event 104, such as update counter 428A. The aggregated update value may be denoted as variable “U.” For example, in the financial transaction context, the aggregated update value may correspond to a total quantity of chargebacks for May 2024.

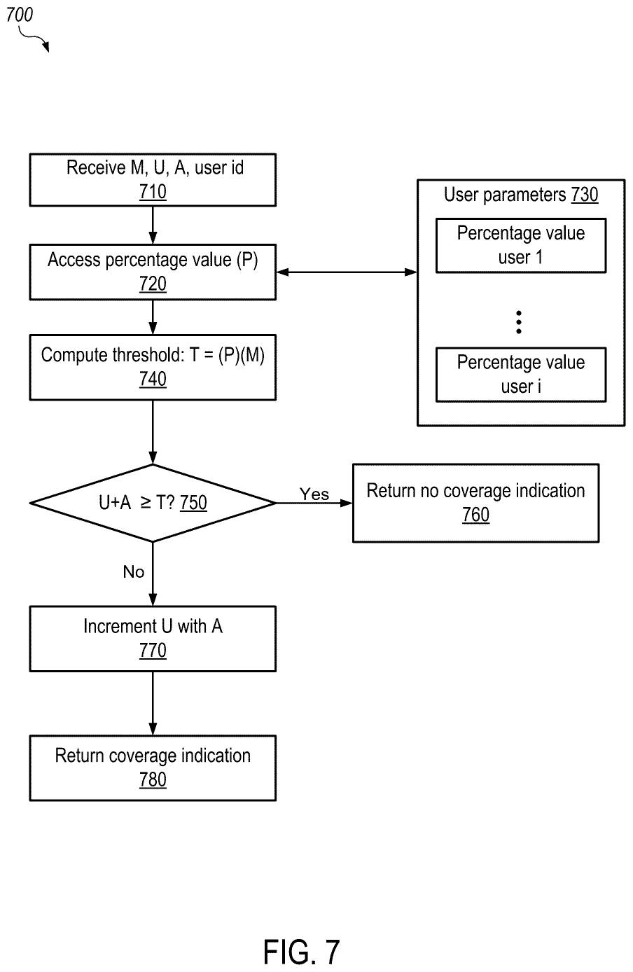

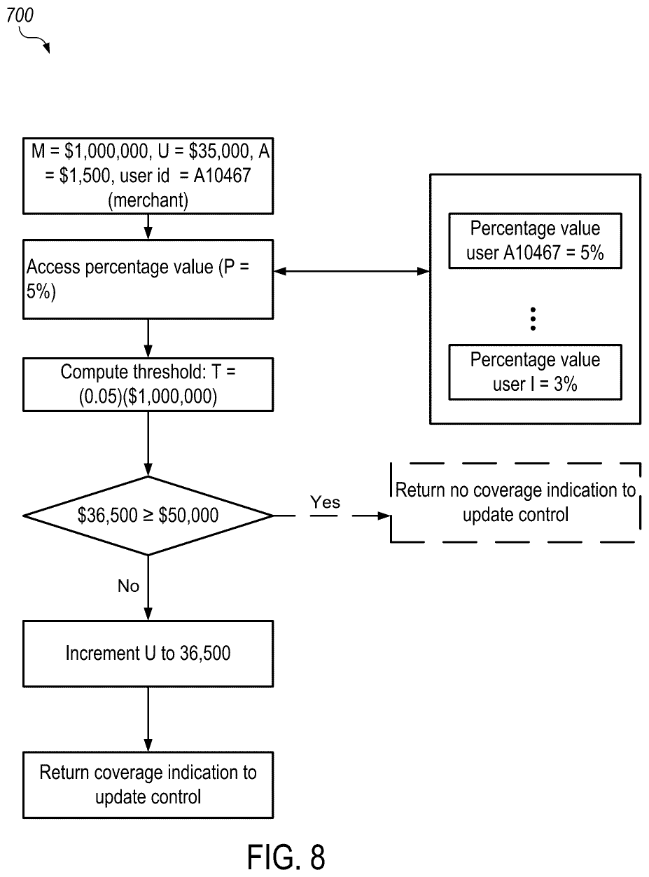

At 656, update event control subsystem 142 is executable to pass values associated with the variables M, U, A to a processing operation executable by processing operating subsystem 146. An example processing operation is discussed more fully with reference to FIGS. 7 and 8 below. Based on the processing operation, at 660, update event control subsystem 142 may be executable to initiate output that the update event is to be handled in a particular way (e.g., the chargeback is authorized to be handled).

At 664, in response to the coverage indication being false (e.g., the chargeback is not a covered chargeback), update event control 142 is executable to perform a similar operation on another update event in the batch file. Otherwise, update event control 142 is operable, at 668, to increment the aggregated update value with the value corresponding to variable A. In the chargeback scenario, this increases the amount of chargebacks that have been covered for a particular time period. In some cases, the chargebacks may eventually reach a limit at which they are no longer covered. Subsequently, update control 142 is executable to perform a similar operation on another update event in the batch file. The method described with reference to FIG. 6B may repeat itself until no unprocessed update events are left in the batch file.

FIG. 7 is a flow diagram of one embodiment of a processing operation. Processing operation subsystem 146 may be executable to perform processing operation 700.

At 710, processing operation subsystem 146 is executable to receive values corresponding to variables M, U, A, the user ID, or a combination thereof from update control 142. Variable “M” corresponds to an aggregated value stored in a metric counter, such as aggregated value 424A stored in metric counter 422A. Variable “U” corresponds to an aggregated update value stored in an update counter, such as aggregated update value 429A stored in update counter 428A. Variable “A” corresponds to an update metric value.

At 720, processing operation subsystem 146 is executable to access user parameters 730 to retrieve, based on user ID, a percentage value, denoted by variable “P,” associated with the user corresponding to the user ID. Each user of computer system 100 may be associated with a different percentage value.

At 740, processing operation subsystem 146 is executable to compute a threshold value, denoted by variable “T,” based on the percentage value and the aggregated value M. In particular, the threshold may be a product of the percentage value and the aggregated value. Such a dynamically adjustable threshold value determination may be difficult or impossible in situations in which computer system 100 parses through a database (e.g., database 130) to identify information from which to determine a value of M. By storing aggregated value M in a counter, the threshold is determinable in real time.

At 750, processing operation subsystem 146 is executable to compute a sum of the aggregated update value U and the update metric value A. Additionally, processing operation subsystem 146 is executable to compare the sum and the threshold.

At 760, in response to the sum of the aggregated update value U and the update metric value A exceeding the threshold value, processing operation subsystem 146 is executable to return indication 154 indicating no coverage (e.g., for the chargeback).

At 770, in response to the sum of the aggregated update value U and the update metric value A failing to exceed the threshold value, processing operation subsystem 146 is executable to increment the aggregated update value U with the update metric value A and is further executable to store the modified aggregated update value U in an update counter, such as update counter 428A. At 780, processing subsystem 146 is executable to return a coverage indication.

FIG. 8 is a flow diagram of a specific example of processing operation 800. The example of FIG. 8 is in a payment service context. As depicted in FIG. 8, an aggregated value variable M (storing the value of $1,000,000) may correspond to a total payment volume (TPV) for a particular month. The aggregated update value U (storing the value of $35,000) may correspond to chargebacks for the same particular month. The update metric value A (storing the value of $1,500) may correspond to a particular chargeback associated with a particular event (e.g., the purchase of a watch) for the same particular month. For instance, the watch purchase might have been determined to be a fraudulent transaction. As explained above with reference to FIG. 7, processing operation subsystem 146 retrieves values from counters to perform a calculation to determine whether to modify aggregated update value with the $1,500 chargeback based on comparing the dynamically calculated threshold (T) to the sum of the aggregated update value (U) and the update metric value (A).

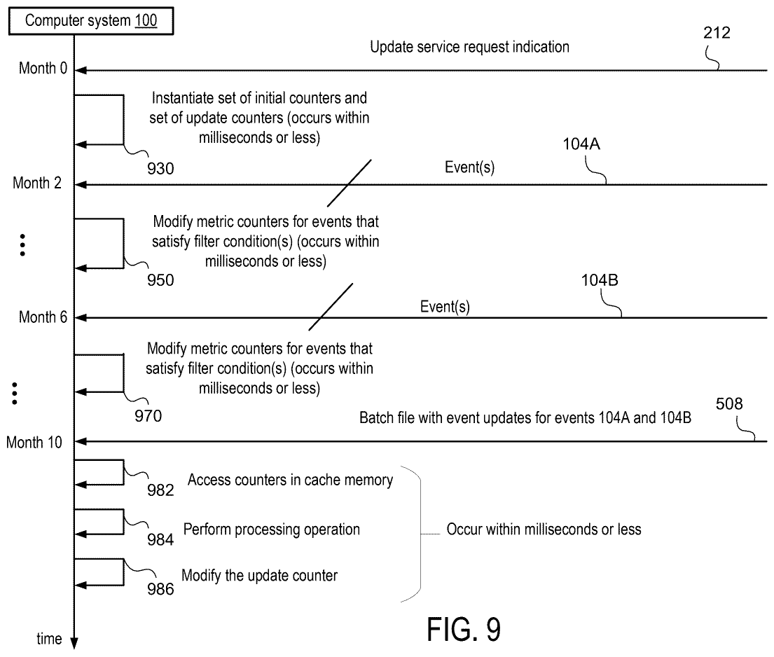

FIG. 9 is an example diagram illustrating temporal aspects of exemplary interactions between computer system 100 and user devices associated with users of an update service implemented on computer system 100.

At an initial time period (e.g., month 0), computer system 100 receives update service request indication 212 from one or more user devices. The update service request indication 212 indicates, in this example, that a user associated with one or more of user devices has instructed computer system 100 to perform an update service as described herein. At 930, in response to receipt of update service request indication 212, computer system 100 is configured to instantiate, for the one or more users associated with the one or more user devices, a set of metric counters and update counters with counter data store 120, as described with reference to FIG. 4A.

At a second time period (e.g., month 2), computer system 100 receives one or more events 104A. At 950, computer system 100 is configured to modify one or more metric counters (e.g., metric counters 120A) based on information included in events 104A for those events of events 104A that have the update service enabled and that satisfy one or more filter parameters (as described with reference to FIG. 2). Consider a particular event received in April 2024; computer system 100 is configured to modify (e.g., increment) an aggregated value stored in a counter corresponding to April 2024 by adding the metric value included in events 104A to the aggregated value.

At a third time period (e.g., month 6), computer system 100 receives one or more events 104B. At 970, computer system 100 is configured to modify one or more metric counters (e.g., metric counters 120A) based on information included in events 104B for those events of events 104B that satisfy one or more filter parameters (as described with reference to FIG. 2). For example, one of events 104B may be associated with a transaction that occurred in June 2024; accordingly, computer system 100 is configured to modify (e.g., increment) an aggregated value stored in a counter corresponding to June 2024 by adding the metric value included in events 104B to the aggregated value.

At a third time period (e.g., month 10), computer system 100 receives batch file 508 that incudes update events corresponding to events 104A and 104B. In response to receipt of the update events, at 982, computer system 100 accesses the counters and update counters corresponding, respectively, to April 2024 and June 2024 and that are associated with events 104A and 104B. Computer system 100 accesses the aggregated values and aggregated update values stored in the respective counters. At 984, computer system 100 performs processing operations based on the aggregated values and aggregated update values. At 986 and based on the logic described with reference to FIGS. 7 and 8, computer system 100 may modify none, one, or both update counters.

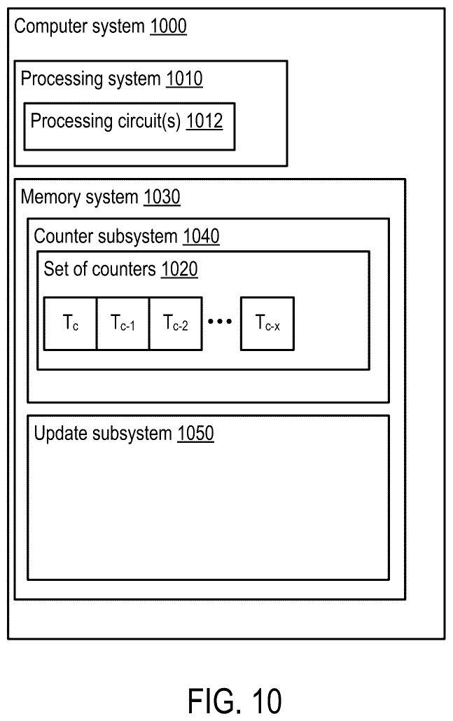

To recap, various embodiments of a system have been described with respect to FIGS. 1, 2, 4A, 4B, and 6A. One such system, with reference to FIG. 10. FIG. 10 is a block diagram illustrating an example of a computer system configured to implement a transaction service. Computer system 1000 may include processing system 1010 including one or more processor circuits 1012. Additionally, computer system 1000 may include memory system 1030 configured to store program instructions executable by the processing system. The program instructions may be executable, by processing system 1010, to implement counter subsystem 1040 executable to manage set of counters 1020 for users of the transaction service. Additionally, the program instructions, when executed by processing system 1010, may implement update subsystem 1050. Counter subsystem 1040 is executable to receive, during a particular time period, an event (104) associated with a transaction between a first user and a second user of the transaction service, the transaction including a parameter having a particular value. Further, counter subsystem 1040 is executable to update, in response to receiving the transaction, a certain counter (422A) of set of counters 1020 that corresponds to the first user and to the particular time period. The certain counter has a current value of the parameter (148, 424A, 428A). The certain counter is updated by adding the particular value to the current value to replace the current value. Update subsystem 1050 is executable to receive, in a later time period that is subsequent to the particular time period, an update event (150) for the transaction. In response to receipt of the update event, update subsystem 1050 is configured to process the update event in real time. To process the update event in real time, update subsystem 1050 is further executable to retrieve, from set of counters 1020, the current value of the parameter for the particular time period, the current value representing an aggregated value of the parameter for transactions involving the first user and occurring during the particular time period. Additionally, update subsystem 1050 is executable to perform a processing operation that uses the current value of the parameter. Moreover, update subsystem 1050 is executable to send an indication (154) of a result (149) of the processing operation to the first user.

In some embodiments, computer system 1000 includes a database system (130) operatable to store transaction details (116) for transactions, including those of the first user, a given set of transaction details including a value of the parameter. The aggregated value (148, 424A, 429A) of the parameter for transactions involving the first user occurs during the particular time period is not derivable from the database system in real time.

In some embodiments, computer system 1000 includes an interface (210) for the first user. Computer system 1000 is operable to receive, via the interface, indications to activate features of the transaction service for the first user, including a particular indication (212) that causes the transaction service to activate the counter subsystem and the update subsystem for subsequent transactions involving the first user.

In some embodiments, counter subsystem 1040 is executable to update the certain counter based on details in the transaction satisfying certain filter parameters (214).

In some embodiments, update subsystem 1050 is executable to perform the processing operation by updating an update counter (428A) with the set of counters within the counter subsystem, the update counter corresponding to updated events for the first user and the particular time period.

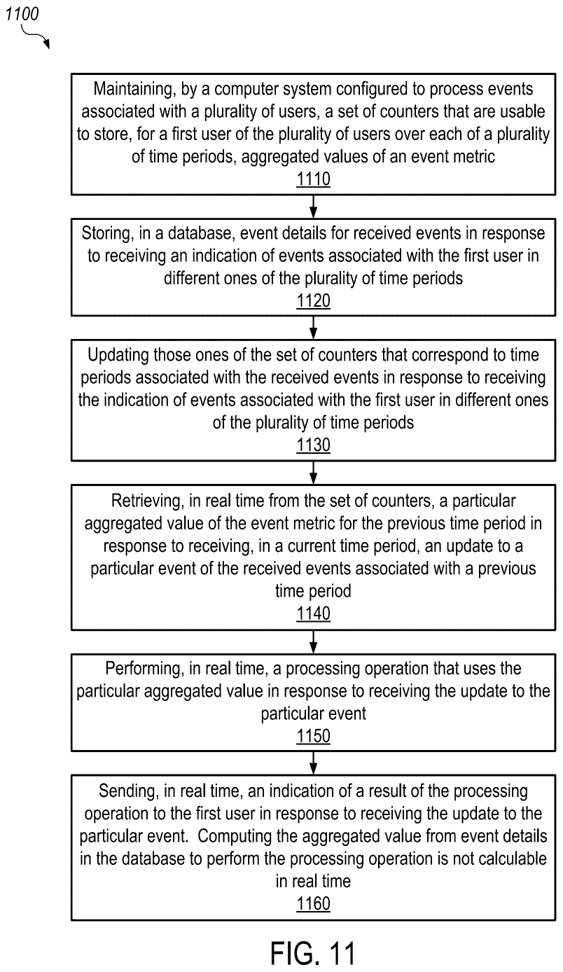

FIG. 11 is a flow diagram of one embodiment of a method for real-time counter-facilitated retrieval of aggregated values for performance of a processing operation. Method 1100 may be performed by a computer system configured to process events associated with a plurality of users. For example, method 1100 may be performed by computer system 100. Method 1100 has many variations, including those described below.

At 1110, the computer system maintains a set of counters that are useable to store, for a first user of a plurality of users over each of a plurality of time periods, aggregated values of an event metric. In some embodiments, the set of counters is maintained in response to the computer system receiving an indication from the first user to provide an update event service.

At 1120, the computer system stores, in a database, event details for received events in response to receipt of an indication of events associated with the first user in different ones of the plurality of time periods.

At 1130, the computer system updates those ones of the set of counters that correspond to time periods associated with the received events in response to receiving the indication of events associated with the first user in different ones of the plurality of time periods.

At 1140, the computer system retrieves, in real time from the set of counters, a particular aggregated value of the event metric from the previous time period in response to receipt, in a current time period, of an update to a particular event of the received events associated with a previous time period.

At 1150, the computer system performs, in real time, a processing operation that uses the particular aggregated value in response to receipt of the update to the particular event.

At 1160, the computer system sends, in real time, an indication of a result of the processing operation to the first user in response to receipt of the update to the particular event. Computing, by the computer system, the aggregated value from event details in the database to perform the processing operation is not calculate in real time.

In some embodiments, the update is included in a batch file that includes updates received for events of the plurality of users since creation of a previous batch file.

In some embodiments, method 1100 includes performing the processing operation for each of the received updates in real time using aggregated values of the event metric retrieved from corresponding counters maintained by the computer system.

In some embodiments, the set of counters also includes update counters for the first user for each of the plurality of time periods.

In some embodiments, the calculating a result of the processing operation includes determining whether a value in an update counter for the previous time period meets a threshold that is based on the particular aggregated value.

In some embodiments, method 1100 further includes updating, in response to determining that the threshold is not met, the update counter for the previous time period.

In some embodiments, events handled by the computer system are payment transactions, the event metric is total payment volume, and the processing operation determines whether an aggregated amount of chargebacks for payment transactions during the previous time period meets the threshold.

In some embodiments, the threshold is a percentage of the total payment volume for the first user during the previous time period, as indicated by the particular aggregated value.

In some embodiments, updating those ones of the set of counters that correspond to time periods associated with the received events includes: determining that information associated with the received events satisfy one or more parameters; and updating those ones of the set of counters that correspond to time periods associated with the received events and that satisfy the one or more parameters.

In some embodiments, the indication of the result of the processing operation specifies that the update is a chargeback relating to the particular transaction.

In some embodiments, the particular event corresponds to a security intrusion event within a computer network, and the update corresponds to a lateral attack related to the particular event.

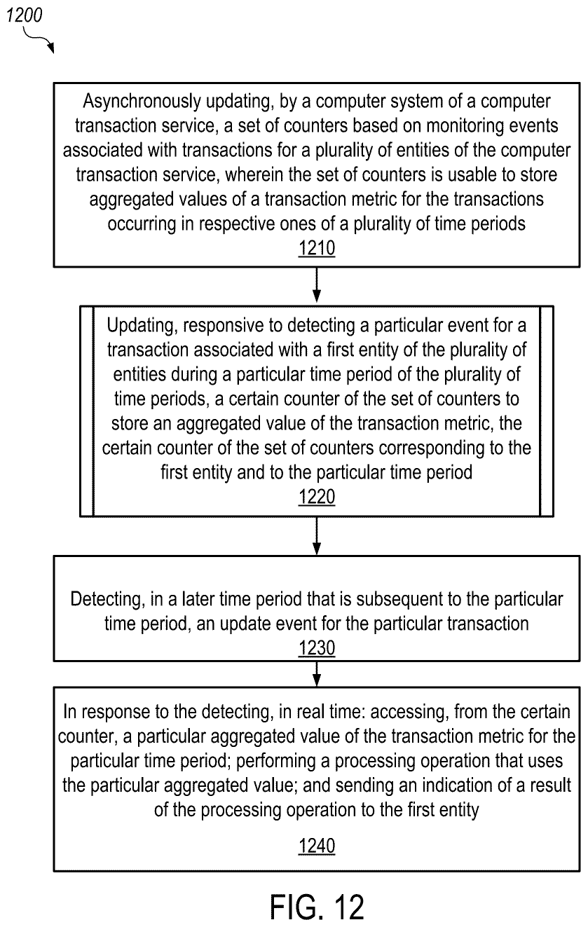

FIG. 12 is a flow diagram of one embodiment of a method for real-time counter-facilitated retrieval of aggregated values for performance of a processing operation. Method 1200 may be performed by a computer system configured to process events associated with a plurality of users. For example, method 1200 may be performed by computer system 100. Method 1200 has many variations, including those described below.

At 1210, a computer system of a computer transaction service asynchronously updates a set of counters based on monitoring events associated with transactions for a plurality of entities of the computer transaction service. The set of counters is usable to store aggregated values of a transaction metric for the transactions occurring in respective ones of a plurality of time periods. “Asynchronous” updates refer to updates that can be performed at irregular intervals, typically without use of an external clock signal.

At 1220, to update the set of counters, the computer system, responsive to detection of a particular event for a transaction associated with a first entity of the plurality of entities during a particular time period of the plurality of time periods, updates a certain counter of the set of counters to store an aggregated value of the transaction metric, the certain counter of the set of counters corresponding to the first entity and to the particular time period.

At 1230, the computer system detects, in a later time period that is subsequent to the particular time period, an update event for the particular transaction.

At 1240, the computer system, in response to the detection, in real time: accesses, from the certain counter, a particular aggregated value of the transaction metric for the particular time period; performs a processing operation that uses the particular aggregated value; and sends an indication of a result of the processing operation to the first entity.

In some embodiments, method 1200 includes updating a transaction database with transaction details for transactions handled by the computer transaction service. The transaction details for a given transaction may include a value of the transaction metric. The particular aggregated value of the transaction metric for the particular time period may not derivable from the transaction database in real time.

In some embodiments, performing the processing operation includes: determining that an update to an update counter associated with the first user and the particular time period is warranted; and updating the update counter with an update transaction metric associated with the update event.

In some embodiments, the set of counters is maintained for the plurality of entities in response to receiving individual indications from the plurality of entities to implement an update service for those entities.

In some embodiments, the update event is detected by reading the updated event from a batch file that includes a plurality of update events.

In some embodiments, the certain counter is updated based on information associated with the particular event satisfying a set of filter parameters.

Various techniques described herein, including methods 1100 and 1200, may be performed by one or more computer programs. The term “program” is to be construed broadly to cover a sequence of instructions in a programming language that a computing device can execute or interpret. These programs may be written in any suitable computer language, including lower-level languages such as assembly and higher-level languages such as Python.

Program instructions may be stored on a “non-transitory, computer-readable storage medium” or a “non-transitory, computer-readable medium.” The storage of program instructions on such media permits execution of the program instructions by a computer system. These are broad terms intended to cover any type of computer memory or storage device that is capable of storing program instructions. The term “non-transitory,” as is understood, refers to a tangible medium. Note that the program instructions may be stored on the medium in various formats (source code, compiled code, etc.). Program instructions embodied on a non-transitory computer-readable storage medium are explicitly contemplated for any disclosed method, including methods 800 and 900.

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. Program instructions stored on a computer-readable medium can be said to “executable” to perform certain functionality, whether or not current software configuration parameters permit such execution. Executability means that when and if the instructions are executed, they perform the functionality in question.

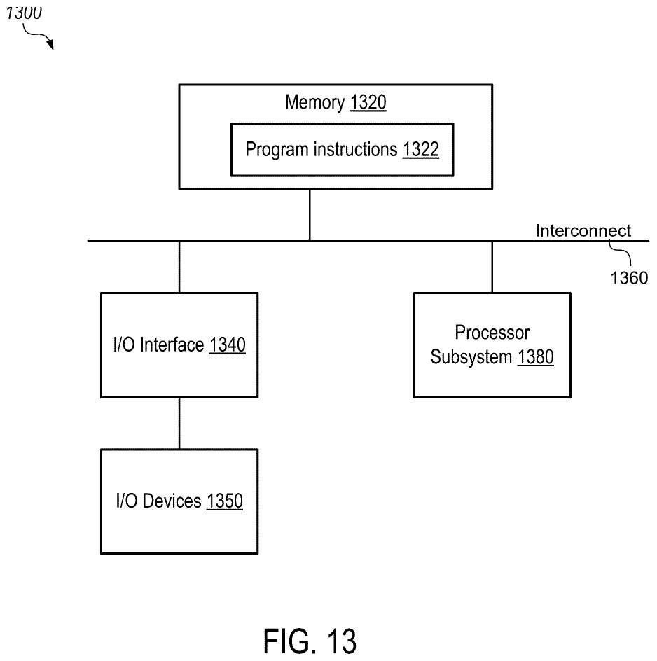

Similarly, systems that implement the methods described with respect to any of the disclosed techniques are also contemplated. One such system was described above with reference to FIG. 10. FIG. 13 is a block diagram of another embodiment of such a computer system. Computer system 1300 includes a processor subsystem 1380 that is coupled to a system memory 1320 and I/O interfaces(s) 1340 via an interconnect 1360 (e.g., a system bus). I/O interface(s) 1340 is coupled to one or more I/O devices 1350. Computer system 1300 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 1300 is shown in FIG. 13 for convenience, system 1300 may also be implemented as two or more computer systems operating together.

Processor subsystem 1380 may include one or more processors or processing units. In various embodiments of computer system 1300, multiple instances of processor subsystem 1380 may be coupled to interconnect 1360. In various embodiments, processor subsystem 1380 (or each processor unit within 1380) may contain a cache or other form of on-board memory.

System memory 1320 is usable to store program instructions executable by processor subsystem 1380 to cause system 1300 perform various operations described herein. System memory 1320 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 1300 is not limited to primary storage such as memory 1320. Rather, computer system 1300 may also include other forms of storage such as cache memory in processor subsystem 1380 and secondary storage on I/O Devices 1350 (e.g., a hard drive, storage array, etc.). In some embodiments, these other forms of storage may also store program instructions executable by processor subsystem 1380.

I/O interfaces 1340 may be any of various types of interfaces configured to couple to and communicate with other devices, according to various embodiments. In one embodiment, I/O interface 1340 is a bridge chip (e.g., Southbridge) from a front-side to one or more back-side buses. I/O interfaces 1340 may be coupled to one or more I/O devices 1350 via one or more corresponding buses or other interfaces. Examples of I/O devices 1350 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 1300 is coupled to a network via a network interface device 1350 (e.g., configured to communicate over Wifi, Bluetooth, Ethernet, etc.).

Memory 1320 may include a non-transitory computer-readable storage medium storing program instructions 1322 in various embodiments. Program instructions 1322 may include instructions that are executable to perform methods 1100 and 1200, for example.

One particular environment in which the disclosed techniques may operate is a cloud computer system. A cloud computer system (or cloud computing system) refers to a computer system that provides on-demand availability of computer system resources without direct management by a user. These resources can include servers, storage, databases, networking, software, analytics, etc. Users typically pay only for those cloud services that are being used, which can, in many instances, lead to reduced operating costs. Various types of cloud service models are possible. The Software as a Service (SaaS) model provides users with a complete product that is run and managed by a cloud provider. The Platform as a Service (PaaS) model allows for deployment and management of applications, without users having to manage the underlying infrastructure. The Infrastructure as a Service (IaaS) model allows more flexibility by permitting users to control access to networking features, computers (virtual or dedicated hardware), and data storage space. Cloud computer systems can run applications in various computing zones that are isolated from one another. These zones can be within a single or multiple geographic regions.

A cloud computer system includes various hardware components along with software to manage those components and provide an interface to users. These hardware components include a processor subsystem, which can include multiple processor circuits, storage, and I/O circuitry, all connected via interconnect circuitry. Cloud computer systems thus can be thought of as server computer systems with associated storage that can perform various types of applications for users as well as provide supporting services (security, load balancing, user interface, etc.).

One common component of a cloud computing system is a data center. As is understood in the art, a data center is a physical computer facility that organizations use to house their critical applications and data. A data center's design is based on a network of computing and storage resources that enable the delivery of shared applications and data.

The term “data center” is intended to cover a wide range of implementations, including traditional on-premises physical servers to virtual networks that support applications and workloads across pools of physical infrastructure and into a multi-cloud environment. In current environments, data exists and is connected across multiple data centers, the edge, and public and private clouds. A data center can frequently communicate across these multiple sites, both on-premises and in the cloud. Even the public cloud is a collection of data centers. When applications are hosted in the cloud, they are using data center resources from the cloud provider. Data centers are commonly used to support a variety of enterprise applications and activities, including, email and file sharing, productivity applications, customer relationship management (CRM), enterprise resource planning (ERP) and databases, big data, artificial intelligence, machine learning, virtual desktops, communications and collaboration services.

Data centers commonly include routers, switches, firewalls, storage systems, servers, and application delivery controllers. Because these components frequently store and manage business-critical data and applications, data center security is critical in data center design. These components operate together provide the core infrastructure for a data center: network infrastructure, storage infrastructure and computing resources. The network infrastructure connects servers (physical and virtualized), data center services, storage, and external connectivity to end-user locations. Storage systems are used to store the data that is the fuel of the data center. In contrast, applications can be considered to be the engines of a data center. Computing resources include servers that provide the processing, memory, local storage, and network connectivity that drive applications. Data centers commonly utilize additional infrastructure to support the center's hardware and software. These include power subsystems, uninterruptible power supplies (UPS), ventilation, cooling systems, fire suppression, backup generators, and connections to external networks.

Data center services are typically deployed to protect the performance and integrity of the core data center components. Data center therefore commonly use network security appliances that provide firewall and intrusion protection capabilities to safeguard the data center. Data centers also maintain application performance by providing application resiliency and availability via automatic failover and load balancing.

One standard for data center design and data center infrastructure is ANSI/TIA-942. It includes standards for ANSI/TIA-942-ready certification, which ensures compliance with one of four categories of data center tiers rated for levels of redundancy and fault tolerance. A Tier 1 (basic) data center offers limited protection against physical occurrences. It has single-capacity components and a single, nonredundant distribution path. A Tier 2 data center offers improved protection against physical occurrences. It has redundant-capacity components and a single, nonredundant distribution path. A Tier 3 data center protects against virtually all physical occurrences, providing redundant-capacity components and multiple independent distribution paths. Each component can be removed or replaced without disrupting services to end users. A Tier 4 data center provides the highest levels of fault tolerance and redundancy. Redundant-capacity components and multiple independent distribution paths enable concurrent maintainability and one fault anywhere in the installation without causing downtime.

Many types of data centers and service models are available. A data center classification depends on whether it is owned by one or many organizations, how it fits (if at all) into the topology of other data centers, the technologies used for computing and storage, and its energy efficiency. There are four main types of data centers. Enterprise data centers are built, owned, and operated by companies and are optimized for their end users. In many cases, they are housed on a corporate campus. Managed services data centers are managed by a third party (or a managed services provider) on behalf of a company. The company leases the equipment and infrastructure instead of buying it. In colocation (“colo”) data centers, a company rents space within a data center owned by others and located off company premises. The colocation data center hosts the infrastructure: building, cooling, bandwidth, security, etc., while the company provides and manages the components, including servers, storage, and firewalls. Cloud data centers are an off-premises form of data center in which data and applications are hosted by a cloud services provider such as AMAZON WEB SERVICES (AWS), MICROSOFT (AZURE), or IBM Cloud.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” be used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

1. A method, comprising:
maintaining, by a computer system configured to process events associated with a plurality of users, a set of counters that is usable to store, for a first user of the plurality of users over each of a plurality of time periods, aggregated values of an event metric;
in response to receiving an indication of events associated with the first user in different ones of the plurality of time periods, the computer system:
storing, in a database, event details for the received events; and
updating those ones of the set of counters that correspond to time periods associated with the received events, wherein the updating is performed based on determining:
counter functionality is enabled for the first user based on comparing an identifier of the first user with a list of user identifiers for which counter functionality is enabled: and
information associated with the received events satisfies a set of filter parameters; and
in response to receiving, in a current time period, an update to a particular event of the received events associated with a previous time period, the computer system, in real time:
retrieving, from the set of counters, a particular aggregated value of the event metric for the previous time period;
performing a processing operation that uses the particular aggregated value, wherein computing the particular aggregated value from event details in the database in order to perform the processing operation is not calculable in real time; and
sending an indication of a result of the processing operation to the first user.

2. The method of claim 1, wherein the set of counters is maintained in response to the computer system receiving an indication from the first user to provide an update event service.

3. The method of claim 1, wherein the update is included in a batch file that includes updates received for events of the plurality of users since creation of a previous batch file, and wherein the method further includes performing the processing operation for each of the received updates in real time using aggregated values of the event metric retrieved from corresponding counters maintained by the computer system.

4. The method of claim 1, wherein the set of counters also includes update counters for the first user for each of the plurality of time periods, and wherein the calculating a result of the processing operation includes determining whether a value in an update counter for the previous time period meets a threshold that is based on the particular aggregated value.

5. The method of claim 4, wherein the processing operation further includes updating, in response to determining that the threshold is not met, the update counter for the previous time period.

6. The method of claim 4, wherein events handled by the computer system are payment transactions, the event metric is total payment volume, and wherein the processing operation determines whether an aggregated amount of chargebacks for payment transactions during the previous time period meets the threshold, wherein the threshold is a percentage of the total payment volume for the first user during the previous time period, as indicated by the particular aggregated value.

7. The method of claim 1, wherein the set of filter parameters includes one or more of the following filter parameters: a time range, a transaction amount, and security characteristics.

8. The method of claim 1, wherein the indication of the result of the processing operation specifies that the update is a chargeback relating to the particular event.

9. The method of claim 1, wherein the particular event corresponds to a security intrusion event within a computer network, and wherein the update corresponds to a lateral attack related to the particular event.

10. A non-transitory, computer-readable medium storing program instructions that are executable on a computer system of a computer transaction service to perform operations comprising:
asynchronously updating a set of counters based on monitoring events associated with transactions for a plurality of entities of the computer transaction service, wherein the set of counters is usable to store aggregated values of a transaction metric for the transactions occurring in respective ones of a plurality of time periods, wherein the updating includes:
updating, responsive to detecting a particular event for a particular transaction associated with a first entity of the plurality of entities during a particular time period of the plurality of time periods, a certain counter of the set of counters to store an aggregated value of the transaction metric, the certain counter of the set of counters corresponding to the first entity and to the particular time period, wherein the updating is performed based on determining:
counter functionality is enabled for the first entity based on comparing an identifier of the first entity with a list of entity identifiers for which counter functionality is enabled; and
information associated with the particular event satisfies a set of filter parameters;
detecting, in a later time period that is subsequent to the particular time period, an update event for the particular transaction; and
in response to the detecting, in real time:
accessing, from the certain counter, a particular aggregated value of the transaction metric for the particular time period;
performing a processing operation that uses the particular aggregated value; and
sending an indication of a result of the processing operation to the first entity.

11. The computer-readable medium of claim 10, wherein the operations comprise:
updating a transaction database with transaction details for transactions handled by the computer transaction service, the transaction details for a given transaction including a value of the transaction metric, wherein the particular aggregated value of the transaction metric for the particular time period is not derivable from the transaction database in real time.

12. The computer-readable medium of claim 10, wherein performing the processing operation includes:
determining that an update to an update counter associated with the first entity and the particular time period is warranted; and
updating the update counter with an update transaction metric associated with the update event.

13. The computer-readable medium of claim 10, wherein the set of counters is maintained for the plurality of entities in response to receiving individual indications from the plurality of entities to implement an update service for those entities.

14. The computer-readable medium of claim 10, wherein the update event is detected by reading the updated event from a batch file that includes a plurality of update events.

15. The computer-readable medium of claim 10, wherein the set of filter parameters includes one or both of a time range filter parameter and a transaction amount filter parameter.

16. A computer system configured to implement a transaction service, the computer system comprising:
a processing system including one or more processor circuits;
a memory system configured to store program instructions executable by the processing system to implement:
a counter subsystem executable to manage a set of counters for users of the transaction service; and
an update subsystem;
wherein the counter subsystem is executable to:
detect, during a particular time period, an event associated with a transaction between a first user and a second user of the transaction service, the transaction including a parameter having a particular value; and
update, in response to receiving the transaction, a certain counter of the set of counters that corresponds to the first user and to the particular time period, wherein the certain counter has a current value of the parameter, and wherein the certain counter is updated by adding the particular value to the current value to replace the current value, wherein the counter subsystem is executable to perform the update based on determining:
counter functionality is enabled for the first user based on comparing an identifier of the first user with a list of user identifiers for which counter functionality is enabled; and
information associated with the transaction satisfies a set of filter parameters; and
wherein the update subsystem is executable to:
detect, in a later time period that is subsequent to the particular time period, an update event for the transaction; and
in response to detection of the update event, process the update event in real time, wherein, to process the update event in real time, the update subsystem is further executable to:
retrieve, from the set of counters, the current value of the parameter for the particular time period, the current value representing an aggregated value of the parameter for transactions involving the first user and occurring during the particular time period;
perform a processing operation that uses the current value of the parameter; and
send an indication of a result of the processing operation to the first user.

17. The computer system of claim 16, further comprising:
a database system operable to store transaction details for transactions, including those of the first user, a given set of transaction details including a value of the parameter;
wherein the aggregated value of the parameter for transactions involving the first user and occurring during the particular time period is not derivable from the database system in real time.

18. The computer system of claim 16, further comprising:
an interface for the first user, wherein the computer system is operable to receive, via the interface, indications to activate features of the transaction service for the first user, including a particular indication that causes the transaction service to activate the counter subsystem and the update subsystem for subsequent transactions involving the first user.

19. The computer system of claim 16, wherein the set of filter parameters includes one or both of a time range filter parameter and a security characteristics filter parameter.

20. The computer system of claim 16, wherein the update subsystem is executable to perform the processing operation by updating an update counter with the set of counters within the counter subsystem, the update counter corresponding to updated events for the first user and the particular time period.
